(19) United States
(12) Patent Application Publication
(10) Pub. No.: US 2026/0212389 A1
(43) Pub. Date: Jul. 23, 2026

(54) INFORMATION PROCESSING APPARATUS, INFORMATION PROCESSING METHOD, AND NON-TRANSITORY COMPUTER-READABLE MEDIUM

(71) Applicant: Nec Corporation, Tokyo (JP)

(72) Inventors: Yasuhiko YOSHIDA, Tokyo (JP); Rui Kondo, Tokyo (JP); Shinnosuke Nishimoto, Tokyo (JP)

(73) Assignee: Nec Corporation, Tokyo (JP)

(21) Appl. No.: 19/440,946

(22) Filed: Jan. 6, 2026

(30) Foreign Application Priority Data
Jan. 20, 2025 (JP) 2025-007698

(51) Int. Cl. G06Q 30/0241; G06Q 30/0207

(52) U.S. Cl. CPC G06Q 30/0277; G06Q 30/0209

(57) ABSTRACT

An information processing device of the present disclosure includes an acquisition unit and an adjustment unit. The acquisition unit acquires advertisement-related information regarding the advertisement in the virtual space of an advertisement publishing desiring user. The adjustment unit sets the mode of the advertisement character existing in the virtual space based on the advertisement-related information.

This application is based upon and claims the benefit of priority from Japanese patent application No. 2025-7698, filed on Jan. 20, 2025, the disclosure of which is incorporated herein in its entirety by reference.

### TECHNICAL FIELD

The present disclosure relates to an information processing device, an information processing method, and a non-transitory computer-readable medium.

### BACKGROUND ART

A technology related to this disclosure is disclosed in WO 2022/264846 A1. WO 2022/264846 A1 discloses a technology related to advertisement activity in a virtual space. In this technology, an advertisement space is provided in advance in the virtual space and sold. An advertisement publisher can purchase an advertisement space and paste an image of their own advertisement to the advertisement space.

### SUMMARY

An example object of this disclosure is to develop a technology related to advertisement activity in a virtual space.

According to one example aspect of the present disclosure,
there is provided an information processing device including
an acquisition means for acquiring advertisement-related information regarding an advertisement in a virtual space of an advertisement publishing desiring user, and
an adjustment means for setting a mode of an advertisement character existing in a virtual space based on the advertisement-related information.

According to one example aspect of the present disclosure,
there is provided an information processing method for causing one or more computers to execute
acquiring advertisement-related information regarding an advertisement in a virtual space of an advertisement publishing desiring user, and
setting a mode of an advertisement character existing in a virtual space based on the advertisement-related information.

According to one example aspect of the present disclosure,
there is provided a program for causing a computer to execute processing including
acquiring advertisement-related information regarding an advertisement in a virtual space of an advertisement publishing desiring user, and
setting a mode of an advertisement character existing in a virtual space based on the advertisement-related information.

According to an example of this disclosure, it is possible to develop a technology related to advertisement activity in a virtual space.

### BRIEF DESCRIPTION OF THE DRAWINGS

FIG. 1 is a diagram illustrating an example of a functional block diagram of an information processing device;

FIG. 2 is a flowchart illustrating an example of a flow of processing of the information processing device;

FIG. 3 is a diagram illustrating an example of a hardware configuration of the information processing device;

FIG. 4 is a diagram illustrating an example of an advertisement character displayed by the information processing device;

FIG. 5 is a diagram illustrating another example of a functional block diagram of the information processing device; and

FIG. 6 is a diagram illustrating another example of a functional block diagram of the information processing device.

### EXAMPLE EMBODIMENT

Hereinafter, an example embodiment of the present disclosure will be described with reference to the drawings. In this disclosure, the drawings are associated with one or more example embodiments. In all the drawings, the same components are denoted by the same reference signs, and description thereof will be omitted as appropriate.

### First Example Embodiment

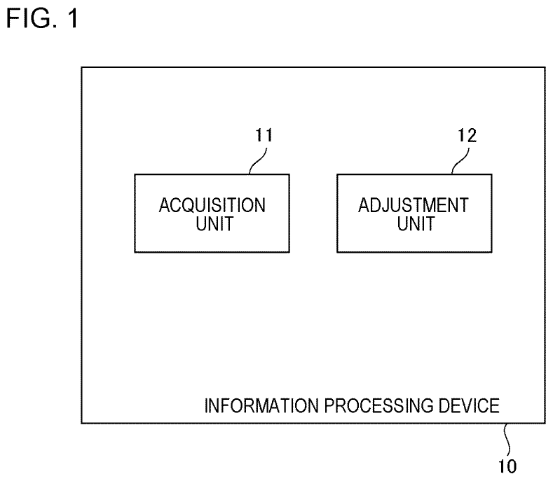

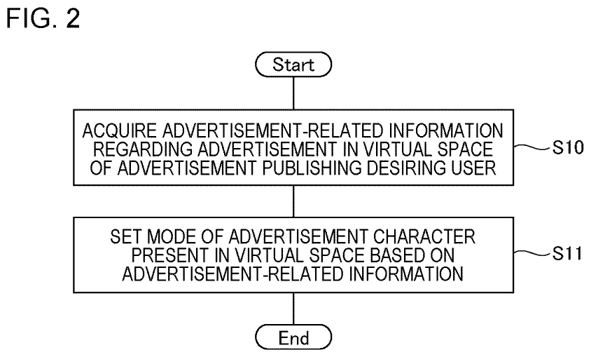

FIG. 1 is a functional block diagram illustrating an outline of an information processing device 10. FIG. 2 is a flowchart illustrating an example of a flow of processing executed by the information processing device 10.

As illustrated in FIG. 1, the information processing device 10 includes an acquisition unit 11 and an adjustment unit 12. The processing illustrated in the flowchart of FIG. 2 is executed by these functional units.

In S10, the acquisition unit 11 acquires advertisement-related information regarding the advertisement in the virtual space of an advertisement publishing desiring user.

In S11, the adjustment unit 12 sets the mode of the advertisement character existing in the virtual space based on the advertisement-related information.

In this manner, the information processing device 10 can set the mode of the advertisement character existing in the virtual space based on the advertisement-related information regarding the advertisement in the virtual space of the advertisement publishing desiring user. That is, the information processing device 10 can customize the mode of the advertisement character existing in the virtual space for each advertisement of the advertisement publishing desiring user. The advertisement publishing desiring user can perform advertisement activities in the virtual space through an advertisement character customized for his/her advertisement.

By causing a character (advertisement character) present in the virtual space to perform an advertisement activity instead of simply publishing an advertisement at a predetermined position in the virtual space, it is possible to perform a more impressive and interesting advertisement activity. As a result, a higher advertising effect is expected.

However, no matter which advertisement activity is performed, if the mode of the advertisement character is the same and the advertisement characters are not differentiated from each other, the impression and fun of the advertisement character are diminished. In a case where many advertisement publishing desiring users use advertisement characters, many advertisement characters exist in the virtual space. Then, if the modes of many of these advertisement characters are the same and are not differentiated from each other, the impression and fun of the advertisement characters are diminished. In such a case, a high advertising effect cannot be expected.

Therefore, the information processing device 10 customizes the mode of the advertisement character for each advertisement. In this way, the mode of the advertisement character is different for each advertisement, and the advertisement characters are differentiated from each other. Then, the impression and fun of each advertisement character are enhanced. Even in a case where many advertisement characters exist in the virtual space, the modes can be made different from each other. As a result, the impression and fun of each advertisement character are enhanced. According to such an information processing device 10, a higher advertising effect is expected. With the mode of the advertisement character adapted to each advertisement, the mode of the advertisement character also becomes an important part of the advertisement activity, and a higher advertising effect is expected.

As described above, according to the information processing device 10, it is possible to develop the technology related to the advertisement activity in the virtual space.

### Second Example Embodiment

### <Overview>

An information processing device 10 of a second example embodiment is obtained by embodying the configuration of the information processing device 10 of the first example embodiment. Details will be described below.

### <Hardware Configuration>

First, an example of a hardware configuration of the information processing device 10 will be described. Each functional unit of the information processing device 10 is achieved by any combination of hardware and software. It is to be understood by those skilled in the art that there are various modification examples of the implementation method and the device. The software includes a program stored in advance from a stage of shipping the device, a program downloaded from a recording medium such as a Compact Disc (CD), a server on the Internet, or the like.

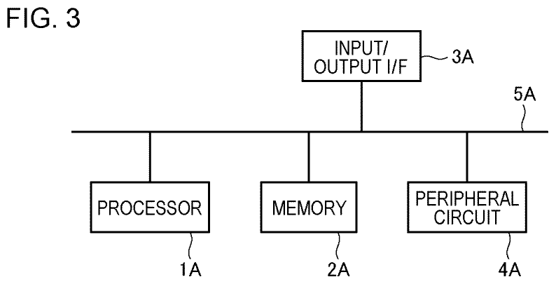

FIG. 3 is a block diagram illustrating a hardware configuration of the information processing device 10. As illustrated in FIG. 3, the information processing device 10 includes a processor 1A, a memory 2A, an input/output interface 3A, a peripheral circuit 4A, and a bus 5A. The peripheral circuit 4A includes various modules. The information processing device 10 does not necessarily include the peripheral circuit 4A. The information processing device 10 may include a plurality of physically and/or logically separated devices. In this case, each of the plurality of devices can have the above-described hardware configuration.

The bus 5A is a data transmission path through which the processor 1A, the memory 2A, the peripheral circuit 4A, and the input/output interface 3A mutually transmit and receive data. The processor 1A is, for example, an arithmetic processing device such as a central processing unit (CPU) or a graphics processing unit (GPU). The memory 2A is, for example, a memory such as a random access memory (RAM) or a read only memory (ROM). The input/output interface 3A includes an interface for acquiring information from an input device, an external device, an external server, an external sensor, a camera, and the like, and an interface for outputting information to an output device, an external device, an external server, and the like. The input/output interface 3A includes an interface for connecting to a communication network such as the Internet. The input device is, for example, a keyboard, a mouse, a microphone, a physical button, a touch panel, or the like. The output device is, for example, a display, a projection device, a speaker, a printer, a mailer, or the like. The processor 1A can issue commands to the modules and execute calculation based on calculation results by the modules.

### <Functional Configuration>

Next, a functional configuration of the information processing device 10 will be described in detail. FIG. 1 is an example of a functional block diagram of the information processing device 10. As illustrated, the information processing device 10 includes the acquisition unit 11 and the adjustment unit 12.

The acquisition unit 11 acquires advertisement-related information regarding the advertisement in the virtual space of an advertisement publishing desiring user.

The “virtual space” is a virtual space constructed on a computer or a network. The virtual space may be a space composed of elements different from those in the real world. In addition, the virtual space may be a space in which the real world is reproduced, that is, a space configured by elements similar to those in the real world. Reproduction of the real world can be implemented by a technology such as a digital twin.

In the virtual space, there are a plurality of characters. The character is called an avatar. The user can operate/control his/her own character existing in the virtual space, interact with other users, and have various experiences. In the virtual space, there is a non-player character controlled by the computer. The non-player character can move in the virtual space or interact with other characters according to the control of the computer. Such a virtual space is known as, for example, a metaverse. The virtual space is created using, for example, various technologies related to the metaverse.

The “advertisement publishing desiring user” is a user who wishes to perform advertisement activities in the virtual space. For example, an organization such as a company may be the advertisement publishing desiring user, or an individual may be the advertisement publishing desiring user.

The “advertisement-related information” is information regarding an advertisement in the virtual space of the advertisement publishing desiring user. The advertisement-related information may include various information regarding the advertisement. The advertisement-related information may include, for example, at least one of the following:
Information regarding advertisement target
Information regarding advertisement activity

### Information Regarding Advertisement Target

The “advertisement target” is a target of an advertisement activity. The advertisement publishing desiring user can set a target that many people want to know as an advertisement target.

For example, the advertisement publishing desiring user can set a product, a service, or the like sold by the user as an advertisement target. The advertisement target may be a product or a service provided in the real world or a product or a service provided in the virtual space. Examples of the product provided in the virtual space include items that can be worn or used by a character. In addition, a mode (motion, expression, etc.) in which a character can be caused to execute a product provided in the virtual space is exemplified. For example, a user who wants his/her character to have a unique mode purchases a product that can cause his/her character to execute a predetermined mode.

The advertisement target is not necessarily a sales target. For example, the advertisement publishing desiring user who wants to become famous may set himself/herself as an advertisement target. The advertisement publishing desiring user who wants to spread his/her idea may set his/her idea as an advertisement target.

The information regarding the advertisement target may include, for example, at least one of the following. The information exemplified here is merely an example, and other information regarding the advertisement target can be included in the information regarding the advertisement target.
Type of advertisement target
Target group of advertisement target
Concept of advertisement target
Feature of advertisement target

The “type of advertisement target” indicates the types of various advertisement targets described above. The type of the advertisement target is, for example, alcohol, tobacco, confectionery, a hotel accommodation service, a human, an idea, an item that can be used in a virtual space, a motion to be executed by a character in the virtual space, or the like, but is not limited thereto.

The “target group of the advertisement target” is a user group in which the advertisement publishing desiring user particularly wants the advertisement target to be known. The target group of the advertisement target is defined by the attribute of the user. Examples of the attribute of the user include, but are not limited to, gender, age, occupation, hobby, preference, medical history, lifestyle, and the like.

The “concept of the advertisement target” is a basic concept or idea at the time of creating the advertisement target. For example, an example of a concept in a case where an advertisement target is alcohol is as follows, but is not limited thereto.
“alcohol that you want someone to drink at the moment they feel relieved at home on a cold winter day after working”

The “feature of the advertisement target” is a portion of appeal of the advertisement target. For example, an example of the feature in a case where the advertisement target is alcohol is as follows, but is not limited thereto.
“Fruity and moderate sweetness. The alcohol content is low. It can be warmed to drink. It can be taken as a hot drink containing moderate alcohol, and has a relaxation effect and a body warming effect.”

### Information Regarding Advertisement Activity

The information regarding the advertisement activity can include information regarding the design of the advertisement character.

The information regarding the advertisement activity may include at least one of appearance information, behavior information, position information, and time information. The appearance information is information regarding the appearance of the advertisement character. For example, information regarding a body shape, a hairstyle, clothes, and an expression may be included as the appearance of the advertisement character. The behavior information is information regarding the behavior of the advertisement character. For example, the behavior of the advertisement character may include a speaking style, a specific dance, a step on the spot, a behavior of reciprocating or circling a predetermined range or distance, and the like. The position information is information regarding the position (coordinates) of the advertisement character. Based on the position information, the advertisement character executes the appearance information and the behavior information at any position in the virtual space. The time information is information for applying the other three pieces of information depending on time. Depending on the time, for example, it is possible to finely determine whether to apply the appearance information, the behavior information, and the position information based on a daily unit or a time unit.

Specifically, the information regarding the advertisement activity may include at least one of the following. The information exemplified here is merely an example, and other information regarding the advertisement activity can be included in the information regarding the advertisement activity.
Setting of advertisement character
Type of advertisement character
Gender of advertisement character
Age of advertisement character
Nationality of advertisement character
Body shape of advertisement character
Speaking style of advertisement character
Unique phrase of advertisement character
Action of advertisement character
Attachment of advertisement character
Belongings of advertisement character
Image of advertisement character
Position of advertisement character in virtual space
Movement route of advertisement character in virtual space
Movement means of advertisement character in virtual space

The “setting of the advertisement character” is a feature given to the advertisement character, and is indicated by a personality, a background, or the like. For example, an example of the setting of the advertisement character is as follows, but is not limited thereto.
“Workaholic. Loving alcohol. The family also likes alcohol. Loving drinking alcohol after coming home from work. On holidays, drinking alcohol from the morning.”

Examples of the “type of advertisement character” include, but are not limited to, a person, another animal (dog, cat, etc.), a robot, a vehicle (cars, trucks, etc.), and a vehicle character.

Examples of “the speaking style of the advertisement character” include, but are not limited to, a polite speaking style, an antique speaking style, a frank speaking style, a rapper speaking style, a youthful speaking style, a political speaking style, and the like.

The “unique phrase of the advertisement character” is a phrase often spoken by the advertisement character or a phrase spoken at a predetermined timing. The unique phrase of the advertisement character is, for example, “I knew it, that's it!”, but is not limited thereto.

The “action of the advertisement character” is an action often performed by the advertisement character or an action performed at a predetermined timing. Examples of the action of the advertisement character include, but are not limited to, waving a hand, jumping twice, and backflip.

The “attachment by the advertisement character” is an article worn by the advertisement character, and examples thereof include, but are not limited to, clothes, hats, masks, glasses, shoes, gloves, and the like. The information regarding the advertisement activity may indicate the type, design, color, and the like of the attachment. The information regarding the advertisement activity may include an image displayed on the attachment. The advertisement publishing desiring user may be able to display the advertisement image on the attachment of the advertisement character.

The “belongings of the advertisement character” are articles carried by the advertisement character. For example, an advertisement target product or an object three-dimensionally depicting the advertisement target product may be possessed by an advertisement character. In addition, a placard, a balloon, or the like for advertisement may be carried by an advertisement character. In this case, the information regarding the advertisement activity may include an image displayed on a placard, a balloon, or the like. The advertisement publishing desiring user may be able to display the advertisement image on the belongings of the advertisement character.

The “image of the advertisement character” is an image illustrating the appearance, belongings, and the like of the advertisement character. The image may be a design picture indicating an advertisement character or a photograph. The image may be a still image or a moving image. In the case of a moving image, the image may indicate an action of an advertisement character. That is, in a case where the image is reproduced, a state in which the advertisement character performs a predetermined action may be indicated. The image may include voice data. Then, the voice data may indicate a unique phrase or a speaking style of the advertisement character. That is, in a case where the image is reproduced, a state in which the advertisement character is speaking a unique phrase or a state in which the advertisement character is speaking in a way specific to the advertisement character may be shown.

The “position of the advertisement character in the virtual space” is a position in the virtual space where the advertisement character is arranged. The advertisement character may continue to exist at a predetermined position in the virtual space. In addition, the advertisement character may move in the virtual space. The advertisement character may go around in one world or move between a plurality of worlds.

The “movement route of the advertisement character in the virtual space” is a route along which the advertisement character moves in the virtual space. The advertisement character may repeatedly move along the determined route.

The “movement means of the advertisement character in the virtual space” is a means for moving the advertisement character in the virtual space. Examples of the movement means include, but are not limited to, walking, a bicycle, a motorcycle, an automobile, and an open car.

The acquisition unit 11 can acquire the above-described advertisement-related information. The acquisition unit 11 can receive the input of the advertisement-related information as described above from the user. The acquisition unit 11 may receive at least a part of the advertisement-related information as described above by inputting a natural language. In addition, the acquisition unit 11 may receive at least a part of the advertisement-related information as described above by an input for selecting the advertisement-related information from options prepared in advance. In addition, the acquisition unit 11 may receive at least a part of the above-described advertisement-related information by inputting (uploading or the like) image data. In addition, the acquisition unit 11 may receive an input of the advertisement-related information indicating a position or a movement route in the virtual space by receiving an input for designating a predetermined position or designating a predetermined movement route on the map of the virtual space.

The acquisition unit 11 can output a user interface (UI) screen to receive the input of the advertisement-related information as described above and receive the input of the advertisement-related information as described above via the UI screen. The advertisement publishing desiring user or the operator who has received the request from the advertisement publishing desiring user inputs the above-described advertisement-related information via the UI screen.

The adjustment unit 12 sets a mode of the advertisement character existing in the virtual space based on the advertisement-related information acquired by the acquisition unit 11.

The “advertisement character” is a character that exists in the virtual space to perform advertisement activities. The advertisement character is a non-player character. One advertisement character may be relevant to one advertisement publishing desiring user. That is, one advertisement character may perform only the advertisement activity of one relevant advertisement publishing desiring user. In addition, one advertisement character may be relevant to a plurality of advertisement publishing desiring users. That is, one advertisement character may perform advertisement activities of a plurality of relevant advertisement publishing desiring users.

The “mode of the advertisement character” includes at least one of setting, type, gender, age, nationality, body shape, speaking style, unique phrase, action, attachment, belongings, appearance, position in a virtual space, movement route in the virtual space, and movement means in the virtual space of the advertisement character. The mode of the advertisement character is specified by one or more of the plurality of items.

The adjustment unit 12 can set the mode of the advertisement character according to the content indicated by the advertisement-related information. That is, in a case where the input advertisement-related information includes the above-described information regarding the advertisement activity and indicates a specific content of the plurality of items as described above, the adjustment unit 12 can set the mode of the advertisement character according to the content.

In addition, the adjustment unit 12 can determine the mode of the advertisement character based on the advertisement-related information. Then, the adjustment unit 12 can set the mode of the advertisement character as determined. For example, in a case where the input advertisement-related information does not include the above-described information regarding the advertisement activity, the adjustment unit 12 can determine the mode of the advertisement character based on the above-described information regarding the advertisement target. Then, the adjustment unit 12 can set the mode of the advertisement character as determined.

In addition, the adjustment unit 12 can set some items of the mode of the advertisement character according to the content indicated by the advertisement-related information. Then, the adjustment unit 12 can determine the other items of the mode of the advertisement character based on the advertisement-related information and set the other items according to the determined content. For example, in a case where the input advertisement-related information indicates a specific content of a part of the information regarding the above-described advertisement activity, that is, a part of the plurality of items as described above, the adjustment unit 12 can set the part of the mode of the advertisement character according to the content. Then, the adjustment unit 12 can determine another part of the mode of the advertisement character based on the above-described information regarding the advertisement target. Then, the adjustment unit 12 can set another part of the mode of the advertisement character as determined.

Here, a process of determining the mode of the advertisement character based on the advertisement-related information will be described. The adjustment unit 12 can determine the mode of the advertisement character using, for example, generative artificial intelligence (AI).

For example, the adjustment unit 12 can input an instruction (prompt) to propose a mode of the advertisement character that performs the advertisement activity of the advertisement target to the generative AI based on the advertisement-related information, and can receive the result. The advertisement-related information used here is at least one of information regarding an advertisement target and information regarding an advertisement activity.

In this prompt, it may be instructed to determine the design (image) of the advertisement character. In this prompt, it may be instructed to determine the setting, type, gender, age, nationality, body shape, speaking style, unique phrase, action, attachment, belongings, movement means, and the like of the advertisement character, and determine the design (image) of the advertisement character based on the result.

In addition, the adjustment unit 12 may perform the process of determining the mode of the advertisement character from the information regarding the advertisement target in two steps.

In the first step, the adjustment unit 12 specifies at least one of the advertisement target and the target group of the advertisement target based on the information regarding the advertisement target. In a case where the information regarding the advertisement target indicates the advertisement target or the target group of the advertisement target, the adjustment unit 12 specifies the content thereof. On the other hand, in a case where the information regarding the advertisement target does not indicate the advertisement target or the target group of the advertisement target, the adjustment unit 12 can estimate the advertisement target or the target group of the advertisement target based on the information regarding the advertisement target. For example, the adjustment unit 12 can input information regarding the advertisement target to the generative AI and can estimate the advertisement target and the target group of the advertisement target based on the information.

In the second step, the adjustment unit 12 determines, based on at least one of the specified advertisement target and the target group of the advertisement target, a mode of an advertisement character suitable for the advertisement target and the target group.

For example, the adjustment unit 12 can input an instruction (prompt) to propose a mode of the advertisement character that performs the advertisement activity of the advertisement target to the generative AI based on at least one of the specified advertisement target and the target group of the advertisement target, and receive the result.

In this prompt, it may be instructed to determine the design (image) of the advertisement character. In this prompt, it may be instructed to determine the setting, type, gender, age, nationality, body shape, speaking style, unique phrase, action, attachment, belongings, movement means, and the like of the advertisement character, and determine the design (image) of the advertisement character based on the result.

Here, another example of the second step will be described. The adjustment unit 12 may determine at least one of the position of the advertisement character in the virtual space and the movement route in the virtual space based on the target group of the advertisement target specified in the first step. For example, the adjustment unit 12 specifies an area in which a relatively large number of target groups of the advertisement target exist based on movement histories of a plurality of users in the virtual space and attributes of a plurality of users registered in advance.

In one example, the adjustment unit 12 may specify an area that satisfies a determination condition for determining that there are a relatively large number of target groups of the advertisement target at the present time. The determination condition is at least one of the following conditions, but is not limited thereto.
Area in which population density of target group of advertisement target is equal to or more than threshold
Area with highest population density of target group of advertisement target
Area in which population of target group of advertisement target is equal to or more than threshold
Area With Largest Population of Target Group of Advertisement Target

In another example, the adjustment unit 12 may specify an area that satisfies a determination condition for determining that there are a relatively large number of target groups of the advertisement target based on the past history. The determination condition is at least one of the following conditions, but is not limited thereto.
Area in which statistical value of population density of target group of advertisement target within latest predetermined time is equal to or more than threshold
Area in predetermined order from higher statistical value of population density of target group of advertisement target within latest predetermined time
Area in which statistical value of population of target group of advertisement target within latest predetermined time is equal to or more than threshold
Area in predetermined order from higher statistical value of population of target group of advertisement target within latest predetermined time

The statistical value is an average value, a maximum value, a minimum value, a mode value, a median value, or the like, but is not limited thereto. There are various ways of obtaining the statistical value. For example, the adjustment unit 12 can obtain a measured value (population or population density) at each time point every predetermined time interval within the latest predetermined time, and calculate a statistical value thereof.

After specifying the area where the target group of the advertisement target is often present as described above, the adjustment unit 12 can determine at least one of the position of the advertisement character in the virtual space and the movement route in the virtual space based on the specification result.

For example, the adjustment unit 12 may determine the area specified in the above processing as the position of the advertisement character in the virtual space. In addition, the adjustment unit 12 may determine, as the movement route of the advertisement character in the virtual space, a movement route that sequentially goes around the plurality of areas specified in the above processing.

The “generative AI” is a concept including a large language model (LLM). The generative AI can include an image analysis model. The generative AI interprets the content of a prompt input in a natural language, generates an answer to the input prompt based on data learned in advance, and outputs the answer expressed in the natural language. The generative AI can receive an input of an image or the like together with the prompt, interpret the content of the input image or the like, and generate an answer reflecting a result of the interpretation. The generative AI can also generate and output an image. Such generative AI is implemented by, for example, a neural network. The neural network includes a plurality of artificial neurons and has synapses connecting the neurons. Each synapse has a weight. In a case where an input is received, such a neural network performs calculation using a weight associated with each synapse, and performs output according to the input. The model representing the connection relationship between the neuron and the synapse is stored in the memory in the form of software, for example. Alternatively, the model may be implemented as a dedicated circuit. Similarly, the weight of each synapse is also stored in the memory in the form of software. A circuit representing a weight may be mounted in a dedicated circuit. In a case where the generative AI is configured using a plurality of models, not all the models are necessarily stored in the same memory. There are various models using such a neural network. The generative AI may be implemented by adopting and replacing various models such as a Transformer, a convolutional neural network (CNN), and a recurrent neural network (RNN).

After determining the mode of the advertisement character by the above-described processing, the adjustment unit 12 sets the mode of the advertisement character as determined. The setting is implemented using various methods.

For example, the adjustment unit 12 can make the appearance of the advertisement character match the appearance of the advertisement character indicated by the advertisement-related information. For example, the adjustment unit 12 may make the appearance of the advertisement character match the appearance of the advertisement character indicated by the image (advertisement-related information). In addition, the adjustment unit 12 may set the content of each item such as clothes and belongings of the advertisement character as indicated by the advertisement-related information. The adjustment unit 12 can make the appearance of the advertisement character match the appearance of the advertisement character determined based on the advertisement-related information. For example, the adjustment unit 12 may cause the generative AI to draw a picture (image) of the advertisement character based on the advertisement-related information. Then, the adjustment unit 12 may make the appearance of the advertisement character match the appearance of the advertisement character indicated by the drawing. In addition, the adjustment unit 12 may cause the generative AI to determine the content of each item such as clothes and belongings of the advertisement character based on the advertisement-related information. Then, the adjustment unit 12 may set the content of each item such as clothes and belongings of the advertisement character as determined by the generative AI.

The adjustment unit 12 can cause the motion of the advertisement character to follow the motion of the advertisement character indicated by the advertisement-related information. The adjustment unit 12 can cause the motion of the advertisement character to follow the motion of the advertisement character determined based on the advertisement-related information.

The adjustment unit 12 can make the speaking style and the phrases of the advertisement character follow the speaking style and the phrases of the advertisement character indicated by the advertisement-related information. The adjustment unit 12 can make the speaking style and the phrases of the advertisement character follow the speaking style and the phrases of the advertisement character determined based on the advertisement-related information.

The adjustment unit 12 can make the belongings of the advertisement character match the belongings of the advertisement character indicated by the advertisement-related information. The adjustment unit 12 can make the belongings of the advertisement character match the belongings of the advertisement character determined based on the advertisement-related information.

The adjustment unit 12 can make the position, movement route, movement means, and the like of the advertisement character in the virtual space match the position, movement route, movement means, and the like of the advertisement character indicated by the advertisement-related information in the virtual space. The adjustment unit 12 can make the position, the movement route, the movement means, and the like of the advertisement character in the virtual space match the position, the movement route, the movement means, and the like of the advertisement character in the virtual space determined based on the advertisement-related information.

By such processing, the mode of the advertisement character in the virtual space is customized for each advertisement based on the advertisement-related information.

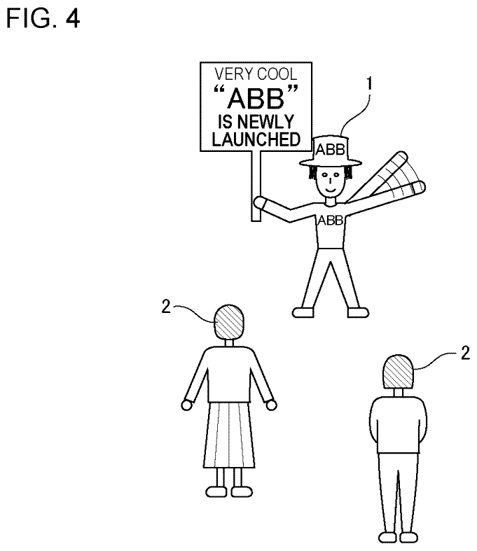

FIG. 4 illustrates an example of an advertisement character 1 whose mode is set by the adjustment unit 12. FIG. 4 illustrates a scene of the virtual space.

In the illustrated example, the advertisement character 1 performs an advertisement activity. Then, the two player characters 2 are looking at the advertisement character 1.

In the illustrated example, the advertisement target is an energy drink, and the product name is “ABB”. The mode of the advertisement character 1 has a content relevant to such an advertisement target. Specifically, characters “ABB” are shown on an outerwear and a hat worn by the advertisement character 1. The advertisement character 1 carries a placard indicating an advertising phrase of an advertisement target. The advertisement character 1 has a mode suitable for a product called energy drink. That is, the advertisement character 1 has an active, energetic, and healthy appearance and motion.

Such a mode of the advertisement character 1 may be content designated by the advertisement publishing desiring user. In addition, the illustrated mode of the advertisement character 1 may be a content determined by the adjustment unit 12 based on the advertisement-related information.

Next, an example of a flow of processing of the information processing device 10 will be described with reference to the flowchart of FIG. 2. An object here is to describe the flow of processing. Since the details of each processing have been described above, the description here is appropriately omitted.

In S10, the information processing device 10 acquires advertisement-related information regarding the advertisement in the virtual space of an advertisement publishing desiring user.

In S11, the information processing device 10 sets the mode of the advertisement character existing in the virtual space based on the advertisement-related information.

An example of the processing of S11 will be described. In one example, first, the information processing device 10 specifies an advertisement character to be subjected to the process of setting the mode from among a plurality of advertisement characters existing in the virtual space.

For example, at least one advertisement character may be associated with the advertisement publishing desiring user who has purchased the right to perform the advertisement activity using the advertisement character. Then, information indicating the association relationship may be registered in the information processing device 10. Based on the information, the information processing device 10 may specify the advertisement character associated with a requester (advertisement publishing desiring user) of the advertisement-related information acquired in S10 as a processing target. Then, the information processing device 10 sets a mode of the advertisement character specified as the processing target based on the advertisement-related information.

### <Operations and Effects>

According to the information processing device 10 of the second example embodiment, operations and effects similar to those of the information processing devices 10 of the first example embodiment can be achieved.

The information processing device 10 can acquire the advertisement-related information specifically designating the content of the mode of the advertisement character, and set the mode of the advertisement character as indicated by the advertisement-related information. According to such an information processing device 10, the advertisement publishing desiring user can set the mode of the advertisement character to desired content. There is a technology in which the user changes the mode of his/her own character (player character) to his/her preference. The technology of making the mode of the advertisement character match the mode indicated by the advertisement-related information input by the user is different from the technology in that the user can set the mode of the advertisement target character that is the non-player character.

The information processing device 10 can determine the content of the mode of the advertisement character based on the advertisement-related information acquired from the advertisement publishing desiring user, and set the mode of the advertisement character based on the determined content. In the case of such an information processing device 10, the advertisement publishing desiring user does not need to create the mode of the advertisement character by himself/herself. As a result, the processing load of the advertisement publishing desiring user can be reduced.

The information processing device 10 determines a mode of the advertisement character based on the advertisement-related information. For example, the information processing device 10 can set the mode of the advertisement character according to the advertisement target, or can set the mode of the advertisement character according to the target group of the advertisement target. According to such an information processing device 10, it is possible to determine the mode of the advertisement character suitable for the advertisement target. As a result, a higher advertising effect is expected.

The information processing device 10 can set at least one of the setting, type, gender, age, nationality, body shape, speaking style, unique phrase, action, attachment, belongings, appearance, position in the virtual space, movement route in the virtual space, and movement means in the virtual space of the advertisement character. According to such an information processing device 10 capable of customizing such various modes, the advertisement publishing desiring user can set the mode of the advertisement character to desired content. Then, by setting the mode of the advertisement character to be suitable for the advertisement target, a higher advertising effect is implemented.

According to the information processing device 10, it is possible to effectively display an advertisement using an advertisement character that is a non-player character in the virtual space. In particular, it can be expected that the mode of the advertisement character is customized based on information of a product, a service, or the like of the advertisement target, the advertisement character is arranged at an appropriate place in the virtual space, and the advertising effect is enhanced through interaction with the user.

### Third Example Embodiment

The advertisement character of a third example embodiment can have various characteristic functions. By using an advertisement character having various characteristic functions, a higher advertising effect is implemented. Details will be described below.

The advertisement character may have at least one of the following functions:
Automatic mode optimization function
Operation advertisement function
Speech advertisement function
Demonstration function
Interactive function
Multi-language function
Link providing function
Individual optimization function
Quest presentation function
Mode correction function

### Automatic Mode Optimization Function

The automatic mode optimization function is “a function in which the adjustment unit 12 determines the mode of the advertisement character based on the advertisement-related information and sets the mode of the advertisement character according to the determined content”. According to the automatic mode optimization function, the information processing device 10 automatically optimizes the mode of the advertisement character. Therefore, the advertisement publishing desiring user does not need to consider the mode of the advertisement character by himself/herself. Details of the function are as described in the second example embodiment.

### Operation Advertisement Function

The operation advertisement function is a function in which an advertisement character performs a predetermined motion as an advertisement activity. The advertisement character can attract user's attention by performing a predetermined motion. The motion includes, but is not limited to, waving a hand, jumping, rotating, and the like. The predetermined motion performed by the operation advertisement function may be an action indicated by the advertisement-related information or an action determined by the adjustment unit 12 based on the advertisement-related information.

The timing at which the predetermined motion is performed varies. The information processing device 10 may cause the advertisement character to perform a predetermined motion every predetermined time, or may cause the advertisement character to perform a predetermined motion at a randomly determined timing. The information processing device 10 may cause the advertisement character to perform a predetermined motion at a timing at which a predetermined execution condition is satisfied. The execution condition is, but not limited to, “the player character has entered an area within a predetermined distance from the advertisement character” or the like.

The function is implemented by a script indicating a predetermined motion, a module for executing the script, a monitoring module for monitoring that an execution condition is satisfied, and the like.

### Speech Advertisement Function

The speech advertisement function is a function in which an advertisement character makes a predetermined speech as an advertisement activity. The advertisement character can attract user's attention by making a predetermined speech. The predetermined speech is, but not limited to, “Attention!”, “Everyone, this is great information!”, and the like. The speech made by the speech advertisement function may be a unique phrase indicated by the advertisement-related information or a unique phrase determined by the adjustment unit 12 based on the advertisement-related information.

The timing of making the predetermined speech varies. The information processing device 10 may cause the advertisement character to perform a predetermined speech every predetermined time, or may cause the advertisement character to perform a predetermined speech at a randomly determined timing. The information processing device 10 may cause the advertisement character to perform a predetermined speech at a timing at which a predetermined execution condition is satisfied. The execution condition is, but not limited to, “the player character has entered an area within a predetermined distance from the advertisement character” or the like.

The function is implemented by a script indicating a predetermined speech, a module for executing the script, a monitoring module for monitoring that an execution condition is satisfied, and the like.

### Demonstration Function

The demonstration function is a function of demonstrating an advertisement target. The advertisement character may demonstrate actual use of the advertisement target product. The advertisement character may demonstrate that the advertisement character actually receives the advertisement target service.

For example, the advertisement character may indicate a state of using a product or a service provided in the real world using a virtual object existing in the virtual space. In addition, the advertisement character may actually wear or use an item (advertisement target product) that can be used in the virtual space. The advertisement character may actually perform a motion, an expression, or the like that can be performed by the character in the virtual space (advertisement target product).

There are various timings for demonstrating. The information processing device 10 may cause the advertisement character to demonstrate at predetermined time intervals, or may cause the advertisement character to demonstrate at randomly determined timing. The information processing device 10 may cause the advertisement character to demonstrate at a timing at which a predetermined execution condition is satisfied. The execution condition is, but not limited to, “the player character has entered an area within a predetermined distance from the advertisement character” or the like.

The function is implemented by a script indicating a predetermined demonstration, a module for executing the script, a monitoring module for monitoring that an execution condition is satisfied, and the like. In addition, a user interface for talking with another character, a reaction analysis module, or the like may be provided.

### Interactive Function

The interactive function is a function of receiving a question from another character existing in the virtual space and answering the question. That is, the advertisement character 1 can have a conversation with another character by the interactive function. The conversation may be performed by voice or chat.

The speech content of the advertisement character in the conversation can be determined using a widely known technology. For example, the information processing device 10 may determine the speech content of the advertisement character in the conversation using the generative AI. By causing the generative AI to learn information regarding the advertisement target in advance, the generative AI can answer a question regarding the advertisement target.

The function is implemented by a question analysis module, an answer generation module, a user interface, or the like.

### Multi-Language Function

The multi-language function is a function of talking in a plurality of languages with another character existing in the virtual space. That is, the advertisement character having the multi-language function can talk with another character in a plurality of languages. The multi-language function can be implemented using widely known technologies.

As a part of the multi-language function, a function of estimating the language of the other party from the speech content of the other party and then setting the own language to the estimated language may be included. In addition, the multi-language function may have a function of receiving the selection of the use language from the other party and then setting one's own language to the selected language.

The function is implemented by a translation module, a language selection module, a user interface, and the like.

### Link Providing Function

The link providing function is a function of providing a link (uniform resource locator (URL)) for accessing a related web page of an advertisement target.

A link for accessing a related web page of an advertisement target is registered in advance in the information processing device 10. The advertisement character having the link providing function can present the link to another character. The related web page of the advertisement target may be a sales site, an introduction page of the advertisement target, or the like.

The timing of presenting the link varies. The information processing device 10 may present the link in response to a request from another character. For example, the information processing device 10 may introduce that there is a related web page of the advertisement target in a conversation with another character via the advertisement character. Then, the information processing device 10 may present the link in response to a request for the web page from another character.

In addition, the information processing device 10 may present the link at a predetermined timing. The predetermined timing is, for example, a timing at which the demonstration on the advertisement target ends, but is not limited thereto.

The function is implemented by a link providing module, a user interface, or the like.

### Individual Optimization Function

The individual optimization function sets the mode of the advertisement character for each other character. The advertisement character having the individual optimization function has different modes such as appearance, motion, and speaking style for each other character (for each user who operates another character).

For example, it is assumed that an advertisement character exists at a position in the virtual space. A plurality of users having a character operated by the user around the advertisement character can visually recognize the advertisement character. That is, the advertisement character is displayed on the screen viewed by each of the plurality of users. Modes (appearance, motion, speaking style, etc.) of the advertisement character viewed from the plurality of users may be different from each other. For example, the advertisement character seen by a certain user is a male. That is, a male advertisement character is displayed on the screen viewed by the user. Then, the advertisement character seen by other users is a female. That is, a female advertisement character is displayed on the screen viewed by other users.

The adjustment unit 12 can determine the mode of the advertisement character based on the attribute or the like of the user and display the advertisement character of the determined mode on the screen of each user. For example, the advertisement-related information acquired by the acquisition unit 11 may indicate a mode of the advertisement character for each attribute of the user. In addition, the adjustment unit 12 may determine the optimum mode of the advertisement character for each attribute of the user based on the advertisement-related information. Then, the adjustment unit 12 determines the mode of the advertisement character for each user based on the attribute of each user, and displays the advertisement character of the mode determined for each user on the screen of each user.

In a case where a plurality of users having a predetermined relationship look at the advertisement character, it is desirable that the advertisement character having the same mode is seen. A plurality of users having a predetermined relationship can have a conversation or the like regarding the advertisement character by looking at the advertisement character of the same mode. Examples of the predetermined relationship include, but are not limited to, a relationship registered in the information processing device 10 as a friend relationship.

In this case, the information processing device 10 can determine whether a plurality of users satisfies a predetermined relationship based on the registered information. Then, the information processing device 10 can display the advertisement characters of the same mode on the screens of a plurality of users satisfying a predetermined relationship.

The function is implemented by a monitoring module that monitors a position of another character and the like, an output adjustment module that sets an output for each user, and the like.

### Quest Presentation Function

The quest presentation function is a function of presenting a quest related to an advertisement target to another character existing in the virtual space. Details of the function will be described in the following example embodiments.

### Mode Correction Function

The mode correction function is a function of changing the mode of the advertisement character based on the advertising effect of the advertisement activity by the advertisement character. Details of the function will be described in the following example embodiments.

Other configurations of the information processing device 10 can be similar to those of the first and second example embodiments.

According to the information processing device 10 of the third example embodiment, operations and effects similar to those of the information processing devices 10 of the first and second example embodiments can be achieved. The information processing device 10 can control an advertisement character having various characteristic functions as described above. By using an advertisement character having various characteristic functions, a higher advertising effect is implemented.

For example, according to the operation advertisement function and the speech advertisement function, attention of other characters can be attracted by motion or speech. According to such an operation advertisement function and a speech advertisement function, an advertising effect can be enhanced.

According to the demonstration function, the advertisement character can perform demonstration regarding the advertisement target in the virtual space and interact with the user. According to such a demonstration function, it is possible to visually and practically convey the attraction of the advertisement target to the user. As a result, the improvement of the advertising effect, the promotion of the user's understanding of the advertisement target, and the like are implemented.

According to the interactive function, the user can make an inquiry about an advertisement target to the advertisement character, and the advertisement character can return an answer to the inquiry. According to such an interactive function, the user can immediately resolve the question about the advertisement target and can deepen the product understanding. As a result, it is expected to increase the user's willingness to purchase.

According to the link providing function, the user can receive a link for accessing a related web page of the advertisement target from the advertisement character and access the page. According to such a link providing function, it is possible to shorten the lead until the user purchases the advertisement target and to improve the conversion rate. That is, sales improvement by simplification of the purchase process is expected.

According to the multi-language function, the advertisement character can advertise the advertisement target in a plurality of languages. According to such a multi-language function, global advertisement deployment becomes possible. As a result, it is possible to avoid loss of a sales opportunity or the like due to a language barrier.

### Fourth Example Embodiment

The advertisement character of a fourth example embodiment has the quest presentation function introduced in the third example embodiment. Then, the information processing device 10 executes processing specific to the function. Details will be described below.

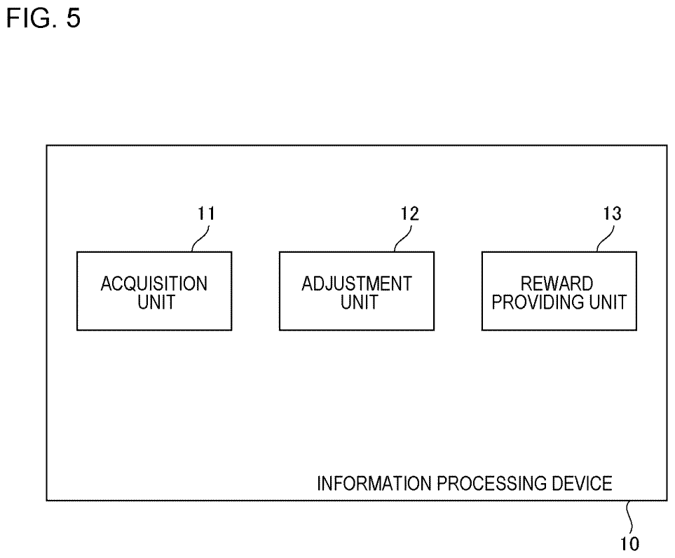

FIG. 5 is an example of a functional block diagram of the information processing device 10. As illustrated, the information processing device 10 includes an acquisition unit 11, an adjustment unit 12, and a reward providing unit 13.

The advertisement character has a quest presentation function. The quest presentation function is a function of presenting a quest related to an advertisement target to another character existing in the virtual space.

The reward providing unit 13 presents a quest related to the advertisement target to another character existing in the virtual space via the advertisement character. Then, the reward providing unit 13 provides a reward to another character who has achieved the quest. The content of the quest is various, and is not particularly limited. For example, the quest may be a predetermined game. There are various contents of the reward, but it is desirable that the reward is related to the advertisement target. For example, the reward may be a discount coupon of an advertisement target product or service. In addition, the reward may be a free trial coupon that allows a user to try a product or a service that is an advertisement target for a predetermined period of time for free. The rewards described here are merely examples, and the present invention is not limited thereto.

For example, the reward providing unit 13 may present the quest to the user who operates another character by displaying a text indicating the content of the quest on the screen. In addition, the reward providing unit 13 may present the quest to the user who operates another character by causing the advertisement character to speak the content of the quest.

After presenting the quest, the reward providing unit 13 monitors whether another character has achieved the quest. If the quest is a game, achieving the quest means clearing the game. Then, the reward providing unit 13 provides a predetermined reward to another character (user) who has achieved the quest. The monitoring of the quest achievement and the provision of the reward can be implemented using widely known technologies.

These functions by the reward providing unit 13 are implemented by a quest management module that generates and provides a quest, a reward management module that monitors quest achievement and provides a reward to an achievement person, and the like.

Other configurations of the information processing device 10 can be similar to those of the first to third example embodiments.

According to the information processing device 10 of the fourth example embodiment, operations and effects similar to those of the information processing devices 10 of the first to third example embodiments can be achieved. The information processing device 10 can provide a quest related to the advertisement target to another character via the advertisement character, and provide a reward related to a product or service of the advertisement target by clearing the quest. According to such an information processing device 10, improvement of user engagement is implemented. As a result, it is expected that the advertisement acceptability of the user is improved by receiving the advertisement while having fun.

### Fifth Example Embodiment

The advertisement character of a fifth example embodiment has the mode correction function introduced in the third example embodiment. Then, the information processing device 10 executes processing specific to the function. Details will be described below.

The advertisement character has a mode correction function. The mode correction function is a function of changing the mode of the advertisement character based on the advertising effect of the advertisement activity by the advertisement character.

The adjustment unit 12 calculates an advertising effect by the advertisement character. Then, the adjustment unit 12 changes the mode of the advertisement character based on the calculated advertising effect.

Here, an example of processing for calculating an advertising effect will be described.

In one example, the adjustment unit 12 can calculate the advertising effect based on various types of data after setting the mode of the advertisement character based on the advertisement-related information.

For example, the data after setting the mode of the advertisement character may be sales data of an advertisement target product or service. The sales data indicates the number of sales and the sales amount in a predetermined period. Then, the adjustment unit 12 may calculate the advertising effect based on the sales data. Although there are various methods for calculating the advertising effect, for example, a sales achievement rate calculated by dividing sales in a predetermined period by target sales set in advance may be calculated as the advertising effect. This calculation method is merely an example, and the calculation method is not limited thereto. The adjustment unit 12 may receive an input of sales data from the advertisement publishing desiring user.

As another example, the data after setting the mode of the advertisement character may be the access frequency to the related web page of the advertisement target. The adjustment unit 12 may calculate the advertising effect based on the access frequency. Although there are various methods for calculating the advertising effect, for example, an access frequency achievement rate calculated by dividing the access frequency in a predetermined period by a preset target access frequency may be calculated as the advertising effect. This calculation method is merely an example, and the calculation method is not limited thereto. The adjustment unit 12 may receive an input of the access frequency from the advertisement publishing desiring user, or may calculate the access frequency to the target web page using a predetermined analysis tool.

As another example, the data after setting the mode of the advertisement character may be the number of times of storing (bookmarking) the link (URL) presented by the link providing function described above (link storing frequency). The adjustment unit 12 may calculate the advertising effect based on the link storing frequency. Although there are various methods for calculating the advertising effect, for example, a link storing frequency achievement rate calculated by dividing the link storing frequency in a predetermined period by a preset target number of times may be calculated as the advertising effect. This calculation method is merely an example, and the calculation method is not limited thereto. The adjustment unit 12 may specify the link storing frequency by monitoring saving of a link which is an action of each user performed by computer processing.

As another example, the data after setting the mode of the advertisement character may be the number of times an advertisement target (for example, the name of the advertisement target) is mentioned in a predetermined social networking service (SNS) (reference frequency). The adjustment unit 12 may calculate the advertising effect based on the reference frequency. Although there are various methods for calculating the advertising effect, for example, a reference frequency achievement rate calculated by dividing the reference frequency in a predetermined period by a preset target reference frequency may be calculated as the advertising effect. This calculation method is merely an example, and the calculation method is not limited thereto. The adjustment unit 12 may receive an input of the reference frequency from the advertisement publishing desiring user, or may acquire the reference frequency published on a predetermined website.

Next, an example of processing of changing the mode of the advertisement character based on the advertising effect will be described.

In one example, the adjustment unit 12 determines whether the advertising effect satisfies the target achievement condition. Then, in a case where the advertising effect satisfies the target achievement condition, the adjustment unit 12 can maintain the mode of the advertisement character as it is. On the other hand, in a case where the advertising effect does not satisfy the target achievement condition, the adjustment unit 12 can change the mode of the advertisement character.

The change of the mode of the advertisement character can be implemented using, for example, the generative AI. The adjustment unit 12 may determine the changed mode of the advertisement character by causing the generative AI to newly propose the mode of the advertisement character by the method described in the second example embodiment.

There are various target achievement conditions. For example, in a case where the advertising effect is indicated by various achievement rates as described above, the target achievement condition may be “the achievement rate is equal to or more than a threshold”.

These functions by the adjustment unit 12 are implemented by a data collection module, an analysis module, an adjustment module for adjusting a mode of an advertisement character, and the like.

Other configurations of the information processing device 10 can be similar to those of the first to fourth example embodiments.

According to the information processing device 10 of the fifth example embodiment, operations and effects similar to those of the information processing devices 10 of the first to fourth example embodiments can be achieved. The information processing device 10 can calculate the advertising effect of the advertisement character and change the mode of the advertisement character based on the calculation result. In one example, in a case where the advertising effect is not achieved to the target, the mode of the advertisement character 1, for example, the appearance, motion, phrases, and the like of the advertisement character can be changed. According to such an information processing device 10, the mode of the advertisement character can be optimized from the viewpoint of the advertising effect. As a result, the advertising effect can be maximized.

### Sixth Example Embodiment

The advertisement character according to a sixth example embodiment optionally has a plurality of functions as described in the third example embodiment, and implements a function selected by the advertisement publishing desiring user. Then, the information processing device 10 determines an advertisement fee paid by the advertisement publishing desiring user according to the selection of the function by the advertisement publishing desiring user. Details will be described below.

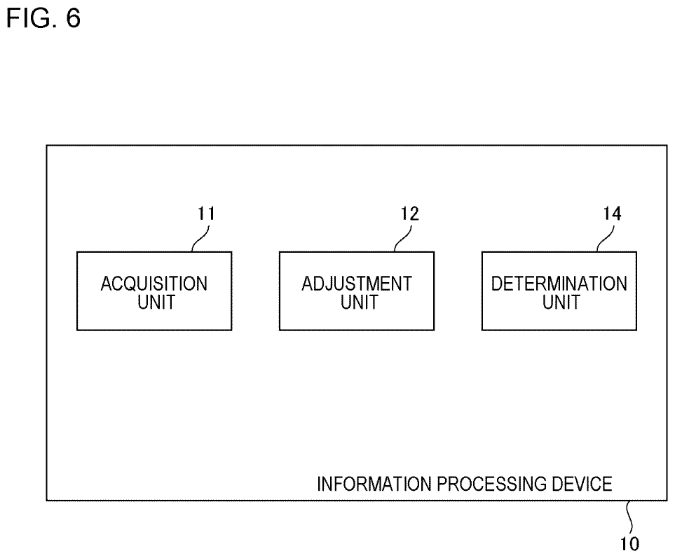

FIG. 6 is an example of a functional block diagram of the information processing device 10. As illustrated, the information processing device 10 includes an acquisition unit 11, an adjustment unit 12, and a determination unit 14. The information processing device 10 may include a reward providing unit 13.

The advertisement character optionally has a plurality of functions. For example, the advertisement character may optionally have at least one of the plurality of functions described in the third example embodiment.

The adjustment unit 12 mounts the function selected from among the options by the advertisement publishing desiring user on the advertisement character. That is, the advertisement publishing desiring user can select a function to be implemented on the advertisement character from among a plurality of options. In one example, the adjustment unit 12 can present a UI screen on which a plurality of functions are displayed in a selectable manner to the user, and receive selection of the function via the UI screen.

The determination unit 14 determines an advertisement fee paid by the advertisement publishing desiring user based on the function selected by the advertisement publishing desiring user.

In one example, a price is determined for each function in advance and registered in the information processing device 10. The determination unit 14 refers to the information indicating the price of each function and specifies the price of the function selected by the advertisement publishing desiring user. Then, the determination unit 14 can determine the total price (option fee) of the selected functions as the advertisement fee paid by the advertisement publishing desiring user.

The advertisement fee paid by the advertisement publishing desiring user may include a fee other than the option fee. For example, the advertisement fee may include a basic fee or the like. The basic fee may be determined according to a length of a period during which the advertisement activity is performed. In this case, the longer the period, the higher the basic fee.

The determination unit 14 can present the determined advertisement fee to the advertisement publishing desiring user. For example, the determination unit 14 may display the determined advertisement fee on a UI screen for selecting a function to be mounted on the advertisement character from among the plurality of options described above. That is, in a case where an input is received to select a function from the advertisement publishing desiring user, the determination unit 14 may calculate the advertisement fee accordingly and display the result on the UI screen. Then, in a case where an input is received to change the selection of the function from the advertisement publishing desiring user, the determination unit 14 may recalculate the advertisement fee accordingly and display a new result on the UI screen.

The determination unit 14 may record the determined advertisement fee in a predetermined storage device in association with the identification information of the advertisement publishing desiring user. The predetermined storage device may be provided in the information processing device 10 or may be provided in an external device communicably connected to the information processing device 10.

Other configurations of the information processing device 10 can be similar to those of the first to fifth example embodiments.

According to the information processing device 10 of the sixth example embodiment, operations and effects similar to those of the information processing devices 10 of the first to fifth example embodiments can be achieved. The information processing device 10 can present a plurality of functions of the advertisement character as options, and can mount the function selected by the advertisement publishing desiring user on the advertisement character. According to such an information processing device 10, the advertisement publishing desiring user can cause the advertisement character to mount only necessary functions. That is, it is possible to suppress an inconvenience that an unnecessary function is mounted on the advertisement character.

The information processing device 10 can determine the advertisement fee paid by the advertisement publishing desiring user according to the function mounted on the advertisement character. In one example, the price is determined for each function. Then, the sum of the prices of the selected functions is determined as the option price. In this case, the advertisement fee increases as the number of selected functions increases. If an expensive function is selected, the advertisement fee increases. Since the advertisement publishing desiring user can cause only necessary functions to be mounted on the advertisement character, the advertisement fee can be optimized.

### Modification Example

Hereinafter, modification examples applicable to the first to sixth example embodiments will be described.

### <First Modified Example>

The advertisement character that emits sound may have a function of changing to a mode that does not emit sound. In this case, each user who operates the player character sets whether to permit the output of sound by the advertisement character existing in the virtual space. In a case where the advertisement character is permitted to output sound, the advertisement character emits sound. On the other hand, in a case where the advertisement character is not permitted to output sound, the advertisement character does not emit sound. In this case, the advertisement character does not emit sound and performs advertisement activity by appearance, motion, or the like.

### <Second Modified Example>

The advertisement character may simultaneously undertake a plurality of advertisement activities. In this case, the adjustment unit 12 can switch the mode of the advertisement character at a predetermined timing.

For example, the schedule of the advertisement activity may be determined for each time zone in a day, such as “13:00 to 15:00: ABC drink of A company” and “15:00 to 18:00: BCB service of B company”. In this example, the advertisement publishing desiring user purchases a right to designate a time and cause the advertisement character to perform an advertisement activity.

Then, the adjustment unit 12 may switch the mode of the advertisement character at a predetermined timing according to the schedule.

In addition, the adjustment unit 12 may change the mode of the advertisement character according to a conversation with another character. For example, the adjustment unit 12 may analyze a conversation content with another character and estimate the preference of the other character (user). Then, the adjustment unit 12 may change the mode of the advertisement character to a mode matching the advertisement target that suits the preference. The adjustment unit 12 can estimate the preference from the conversation content using, for example, the generative AI.

### <Third Modified Example>

The advertisement character may be arranged in a shopping mall in the virtual space and perform advertisement activity there. The advertisement character can introduce an advertisement target through demonstration or the like, answer a question of another character, and present a link for accessing a related web page to another character. According to such an information processing device 10, the purchasing experience in the virtual space is improved. As a result, the shopping experience in the virtual space can be enhanced. Such a function is implemented by a product introduction module, a question handling module, a purchase link providing module, and the like.

### <Fourth Modified Example>

As described in the fifth example embodiment, the information processing device 10 can calculate an advertising effect based on various types of data after setting the mode of the advertisement character based on the advertisement-related information, and change the mode of the advertisement character based on the calculated advertising effect.

The information processing device 10 may be configured by a plurality of servers, and the processing load may be reduced by sharing the processing among the plurality of servers.

The first server collects various kinds of data after the mode of the advertisement character is set based on the advertisement-related information. The second server calculates an advertising effect based on the collected various data. The third server changes the mode of the advertisement character based on the calculated advertising effect.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

In the flowchart used in the descriptions above, a plurality of steps (processes) is described in order. However, an execution order of the steps executed in each example embodiment is not limited to the described order. In each example embodiment, the order of the illustrated steps can be changed as long as nothing interferes in terms of content.

Some or all of the above example embodiments may be described as the following Supplementary Notes, but are not limited to the following.
1. An information processing device including:
   an acquisition means for acquiring advertisement-related information regarding an advertisement in a virtual space of an advertisement publishing desiring user; and
   an adjustment means for setting a mode of an advertisement character existing in a virtual space based on the advertisement-related information.
2. The information processing device according to 1, in which
   the adjustment means
   sets at least one of appearance information, behavior information, position information, and time information based on the advertisement-related information.
3. The information processing device according to 1 or 2, in which
   the adjustment means
   specifies at least one of an advertisement target and a target group of the advertisement target based on the advertisement-related information, and sets a mode of the advertisement character based on a result of the specification.
4. The information processing device according to any one of 1 to 3, in which
   the advertisement character includes at least one of:
   an automatic mode optimization function of determining and setting a mode of the advertisement character based on the advertisement-related information; and
   a mode correction function of changing a mode of the advertisement character based on an advertising effect.
5. The information processing device according to any one of 1 to 4, further including a reward providing means for presenting a quest related to an advertisement target to another character existing in the virtual space via the advertisement character and providing a reward to the another character that has achieved the quest.
6. The information processing device according to any one of 1 to 5, in which
   the adjustment means
   calculates an advertising effect of the advertisement character, and
   changes a mode of the advertisement character based on the advertising effect.
7. The information processing device according to any one of 1 to 6, in which
   the advertisement character optionally has a plurality of functions,
   the adjustment means mounts a function selected by the advertisement publishing desiring user on the advertisement character, and
   the information processing device further includes a determination means for determining an advertisement fee paid by the advertisement publishing desiring user based on a function selected by the advertisement publishing desiring user.
8. The information processing device according to any one of 1 to 7, in which the advertisement character is a non-player character controlled by a computer.
9. An information processing method for causing at least one computer to execute:
   acquiring advertisement-related information regarding an advertisement in a virtual space of an advertisement publishing desiring user; and
   setting a mode of an advertisement character existing in a virtual space based on the advertisement-related information.
10. A program for causing a computer to execute processing including:
   acquiring advertisement-related information regarding an advertisement in a virtual space of an advertisement publishing desiring user; and
   setting a mode of an advertisement character existing in a virtual space based on the advertisement-related information.

Some or all of Supplementary Notes 2 to 8 dependent on the information processing device of Supplementary Note 1 described above can also be dependent on the information processing method of Supplementary Note 9 and the program of Supplementary Note 10 by dependency relationship similar to Supplementary Note 1 and Supplementary Notes 2 to 8. Furthermore, a part or all of the configuration described as a supplementary note can be achieved in various pieces of hardware and software, and various recording means for recording software, or systems without departing from the above-described example embodiments.

1. An information processing apparatus comprising:
at least one memory configured to store one or more instructions; and
at least one processor configured to execute the one or more instructions to:
acquire advertisement-related information regarding an advertisement in a virtual space of an advertisement publishing desiring user; and
set a mode of an advertisement character existing in a virtual space based on the advertisement-related information.

2. The information processing apparatus according to claim 1, wherein
the at least one processor is further configured to execute the one or more instructions to
set at least one of appearance information, behavior information, position information, and time information based on the advertisement-related information.

3. The information processing apparatus according to claim 1, wherein
the at least one processor is further configured to execute the one or more instructions to
specify at least one of an advertisement target and a target group of the advertisement target based on the advertisement-related information, and
set a mode of the advertisement character based on a result of the specification.

4. The information processing apparatus according to claim 1, wherein
the advertisement character comprises at least one of:
an automatic mode optimization function of determining and setting a mode of the advertisement character based on the advertisement-related information; and
a mode correction function of changing a mode of the advertisement character based on an advertising effect.

5. The information processing apparatus according to claim 1, wherein
the at least one processor is further configured to execute the one or more instructions to
present a quest related to an advertisement target to another character existing in the virtual space via the advertisement character and
provide a reward to the another character that has achieved the quest.

6. The information processing apparatus according to claim 1, wherein
the at least one processor is further configured to execute the one or more instructions to
calculate an advertising effect of the advertisement character, and
change a mode of the advertisement character based on the advertising effect.

7. The information processing apparatus according to claim 1, wherein
the advertisement character optionally comprises a plurality of functions,
the at least one processor is further configured to execute the one or more instructions to
mount a function selected by the advertisement publishing desiring user on the advertisement character, and
determine an advertisement fee paid by the advertisement publishing desiring user based on a function selected by the advertisement publishing desiring user.

8. The information processing apparatus according to claim 1, wherein the advertisement character is a non-player character controlled by a computer.

9. An information processing method for causing at least one computer to execute:
acquiring advertisement-related information regarding an advertisement in a virtual space of an advertisement publishing desiring user; and
setting a mode of an advertisement character existing in a virtual space based on the advertisement-related information.

10. The information processing method according to claim 9, wherein
the at least one computer sets at least one of appearance information, behavior information, position information, and time information based on the advertisement-related information.

11. The information processing method according to claim 9, wherein
at least one computer
specifies at least one of an advertisement target and a target group of the advertisement target based on the advertisement-related information, and
sets a mode of the advertisement character based on a result of the specification.

12. The information processing method according to claim 9, wherein
the advertisement character comprises at least one of:
an automatic mode optimization function of determining and setting a mode of the advertisement character based on the advertisement-related information; and
a mode correction function of changing a mode of the advertisement character based on an advertising effect.

13. The information processing method according to claim 9, wherein
at least one computer
presents a quest related to an advertisement target to another character existing in the virtual space via the advertisement character and
provides a reward to the another character that has achieved the quest.

14. The information processing method according to claim 9, wherein
at least one computer
calculates an advertising effect of the advertisement character, and
changes a mode of the advertisement character based on the advertising effect.

15. A non-transitory computer-readable medium storing a program for causing a computer to:
acquire advertisement-related information regarding an advertisement in a virtual space of an advertisement publishing desiring user; and
set a mode of an advertisement character existing in a virtual space based on the advertisement-related information.

16. The non-transitory computer-readable medium according to claim 15, wherein
the program causes a computer to
set at least one of appearance information, behavior information, position information, and time information based on the advertisement-related information.

17. The non-transitory computer-readable medium according to claim 15, wherein
the program causes a computer to
specify at least one of an advertisement target and a target group of the advertisement target based on the advertisement-related information, and
set a mode of the advertisement character based on a result of the specification.

18. The non-transitory computer-readable medium according to claim 15, wherein
the advertisement character comprises at least one of:
an automatic mode optimization function of determining and setting a mode of the advertisement character based on the advertisement-related information; and
a mode correction function of changing a mode of the advertisement character based on an advertising effect.

19. The non-transitory computer-readable medium according to claim 15, wherein
the program causes a computer to
present a quest related to an advertisement target to another character existing in the virtual space via the advertisement character and
provide a reward to the another character that has achieved the quest.

20. The non-transitory computer-readable medium according to claim 15, wherein
the program causes a computer to
calculate an advertising effect of the advertisement character, and
change a mode of the advertisement character based on the advertising effect.
